(19) United States
(12) Patent Application Publication
(10) Pub. No.: US 2018/0348771 A1
(43) Pub. Date: Dec. 6, 2018

(54) STOP CONTINGENCY PLANNING DURING AUTONOMOUS VEHICLE OPERATION

(71) Applicant: GM GLOBAL TECHNOLOGY OPERATIONS LLC, Detroit, MI (US)

(72) Inventors: Kevin Chu, San Mateo, CA (US); SHIVA GHOSE, BERKLEY, CA (US); SOHRAB HAGHIGHAT, EMERYVILLE, CA (US); BROOKS REED, SAN FRANCISCO, MI (US)

(73) Assignee: GM GLOBAL TECHNOLOGY OPERATIONS LLC, Detroit, MI (US)

(21) Appl. No.: 16/045,907

(22) Filed: Jul. 26, 2018

(51) Int. Cl. G05D 1/02; G07C 5/08; G05D 1/00; B60W 30/095; B60W 30/09

(52) U.S. Cl. CPC G05D 1/0214; G07C 5/0808; G05D 1/0088; B60W 2550/10; B60W 30/09; G05D 2201/0213; B60W 30/0956

(57) ABSTRACT

Systems and method are provided for controlling a vehicle. In one embodiment, a method includes: monitoring a health of the vehicle; generating a first driving plan; generating a second driving plan configured to bring the vehicle to a stop at a predetermined rate; commanding the vehicle to execute the first driving plan in response to the health of the vehicle staying above a predetermined health threshold; and commanding the vehicle to execute the second driving plan in response to the health of the vehicle falling below the predetermined health threshold.

### INTRODUCTION

The present disclosure generally relates to autonomous vehicles, and more particularly relates to systems and methods for stopping the vehicle when the health of the vehicle is poor.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

While autonomous vehicles offer many potential advantages over traditional vehicles, in certain circumstances it may be desirable for improved movement of autonomous vehicles, for example in response to unavailability of various systems of the autonomous vehicle.

Accordingly, it is desirable to provide systems and methods pertaining to stopping the autonomous vehicle in response to unavailability of the various systems. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for controlling a vehicle. In one embodiment, a method includes: monitoring a health of the vehicle; generating a first driving plan; generating a second driving plan configured to bring the vehicle to a stop at a predetermined rate; commanding the vehicle to execute the first driving plan in response to the health of the vehicle staying above a predetermined health threshold; and commanding the vehicle to execute the second driving plan in response to the health of the vehicle falling below the predetermined health threshold.

In some embodiments, the method further includes receiving sensor inputs indicating a potential obstacle and adjusting the second driving plan based on the potential obstacle.

In some embodiments, the method further includes generating the first driving plan including generating the first driving plan configured to guide the vehicle to a trip destination and generating a lateral component and generating a longitudinal component.

In some embodiments, the method further includes determining whether the lateral component is a valid lateral component; determining whether the longitudinal component is a valid longitudinal component; retrieving a previous valid lateral component as the lateral component in response to determining that the lateral component is not the valid lateral component; and retrieving a previous valid longitudinal component as the longitudinal component in response to determining that the longitudinal component is not the valid longitudinal component.

In some embodiments, the method further includes commanding the vehicle to execute a hard stop in response to determining that a component confidence in one of the previous valid lateral component and the previous valid longitudinal component is below a predetermined confidence threshold.

In some embodiments, the method further includes tracking a potential obstacle based on sensor inputs; predicting a future position of the potential obstacle based on the sensor inputs; and calculating a confidence in the future position as at least part of the component confidence. In some embodiments, the predetermined rate is at least partially based on predetermined driver reaction times to permit a driver following the vehicle to react to the vehicle decelerating while the vehicle is executing the second driving plan.

In some embodiments, the method further includes receiving updated sensor inputs and updating the second driving plan based on the updated sensor inputs after commanding the vehicle to execute the second driving plan.

In one embodiment, a system for controlling a vehicle includes a motion planning module and a plan implementation module. The motion planning module is configured to at least facilitate, by a processor: monitoring a health of the vehicle; generating a first driving plan configured to guide the vehicle to a trip destination; and generating a second driving plan configured to bring the vehicle to a stop at a predetermined rate. The plan implementation module is configured to at least facilitate, by the processor: commanding the vehicle to execute the first driving plan in response to the health of the vehicle staying above a predetermined health threshold; and commanding the vehicle to execute the second driving plan in response to the health of the vehicle falling below the predetermined health threshold.

In some embodiments, the motion planning module is further configured to at least facilitate: receiving sensor inputs indicating a potential obstacle; and adjusting the second driving plan based on the potential obstacle.

In some embodiments, the motion planning module is further configured for generating the second driving plan by generating a lateral component and generating a longitudinal component.

In some embodiments, the plan implementation module is further configured to at least facilitate: determining whether the lateral component is a valid lateral component; determining whether the longitudinal component is a valid longitudinal component; retrieving a previous valid lateral component as the lateral component in response to determining that the lateral component is not the valid lateral component; and retrieving a previous valid longitudinal component as the longitudinal component in response to determining that the longitudinal component is not the valid longitudinal component.

In some embodiments, the plan implementation module is further configured to at least facilitate commanding the vehicle to execute a hard stop in response to determining that a component confidence in one of the previous valid lateral component and the previous valid longitudinal component is below a predetermined confidence threshold.

In some embodiments, the motion planning module is further configured to at least facilitate: tracking a potential obstacle based on sensor inputs; predicting a future position of the potential obstacle based on the sensor inputs; and calculating a confidence in the future position as at least part of the component confidence. In some embodiments, the predetermined rate is at least partially based on predetermined driver reaction times to permit a driver following the vehicle to react to the vehicle decelerating while the vehicle is executing the second driving plan.

In some embodiments, the motion planning module is further configured to at least facilitate receiving updated sensor inputs and updating the second driving plan based on the updated sensor inputs after commanding the vehicle to execute the second driving plan.

In one embodiment, an autonomous vehicle includes an autonomous drive system, a plurality of sensors, and a processor. The autonomous drive system is configured to operate the autonomous vehicle based on instructions that are based at least in part on a health of the vehicle. The plurality of sensors are configured to obtain sensor data pertaining to one or more potential obstacles in proximity to the autonomous vehicle. The processor is operatively coupled with the plurality of sensors and to the autonomous drive system. The processor is configured to at least facilitate: monitoring the health of the vehicle; generating a first driving plan configured to guide the vehicle to a trip destination; generating a second driving plan configured to bring the vehicle to a stop at a predetermined rate; commanding the vehicle to execute the first driving plan in response to the health of the vehicle staying above a predetermined health threshold; and commanding the vehicle to execute the second driving plan in response to the health of the vehicle falling below the predetermined health threshold.

In some embodiments, the processor is further configured to at least facilitate: receiving sensor inputs indicating the one or more potential obstacles; and adjusting the second driving plan based on the potential obstacle.

In some embodiments, the processor is further configured to at least facilitate: determining whether a component of the second driving plan is a valid component; and retrieving a previous valid component as the component in response to determining that the component is not the valid component.

In some embodiments, the processor is further configured to at least facilitate commanding the vehicle to execute a hard stop in response to determining that a component confidence in the valid component is below a predetermined confidence threshold.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a stop contingency system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the stop contingency system of the autonomous vehicle, in accordance with various embodiments;

FIG. 5 is a schematic diagram of the autonomous vehicle on a roadway proximate a potential obstacle, in accordance with various embodiments; and

FIGS. 6-7 are flowcharts illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

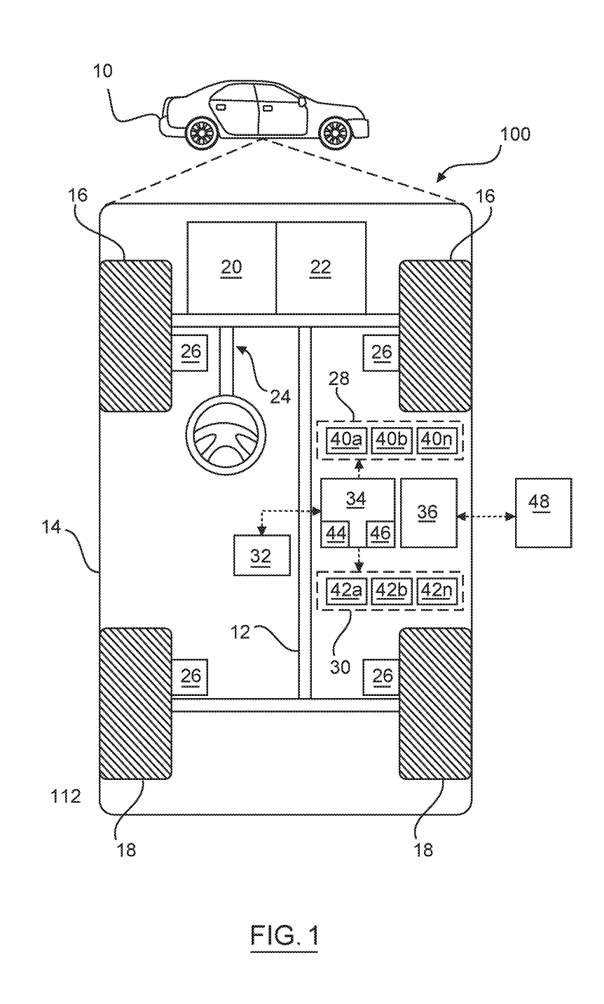

With reference to FIG. 1, a stop contingency system shown generally at 100 is associated with a vehicle 10 in accordance with various embodiments. In general, the stop contingency system 100 continuously plans both a “normal” driving plan and a stop contingency driving plan to be used to stop the vehicle when the driving planning modules or sensors are not responsive.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the stop contingency system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

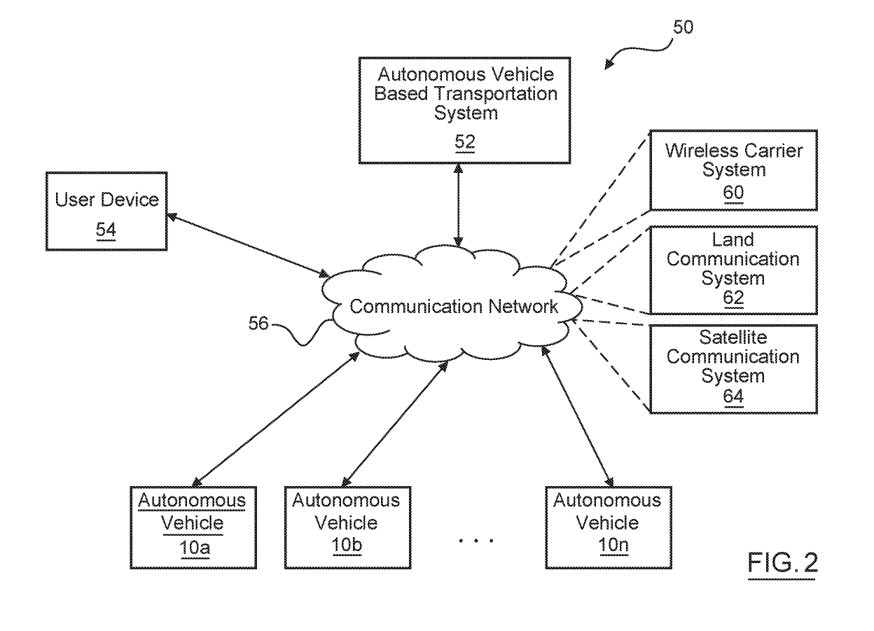

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the stop contingency system 100 and, when executed by the processor 44, generates a normal driving plan and a stop contingency driving plan to be driven when a health of the vehicle 10 is poor.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

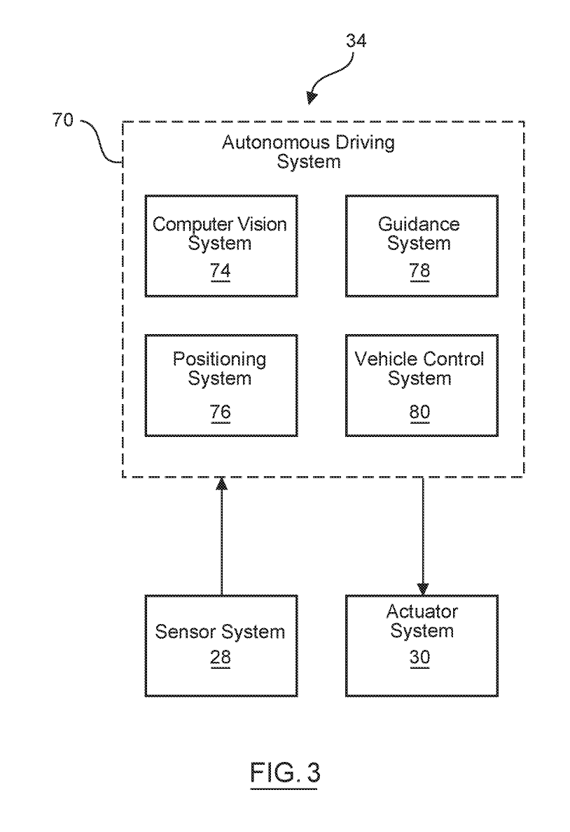

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the stop contingency system 100 of FIG. 1 is included within the ADS 70, for example, as portions of the guidance system 78 and the vehicle control system 80 configured to generate a normal driving plan and a stop contingency driving plan.

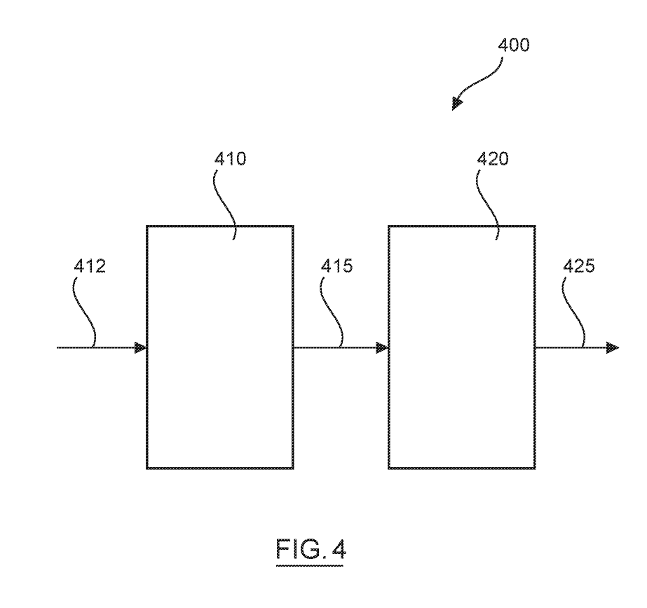

For example, as shown in more detail with regard to FIG. 4 and with continued reference to FIG. 3, the stop contingency system 400 includes a motion planning module 410 and a plan implementation module 420. In various embodiments, the motion planning module 410 and the plan implementation module 420 are disposed onboard the vehicle 10. As can be appreciated, in various embodiments, parts of the stop contingency system 400 may be disposed on a system remote from the vehicle 10 while other parts of the stop contingency system 400 may be disposed on the vehicle 10.

In various embodiments, the motion planning module 410 receives sensor data 412 from various sensors 40a-40n of the vehicle 10 (e.g., lidar sensors, radar sensors, cameras, and so on). The motion planning module 410 gathers the sensor data 412 in order to obtain information pertaining to one or more potential obstacles in proximity to the vehicle 10, to an environment surrounding the vehicle 10, and to the availability and health of various vehicle systems. In various embodiments, the sensor data 412 is obtained via the sensors 40a-40n of FIG. 1. In various embodiments, the sensor data 412 may include, among other data, a type of potential obstacle (e.g., another vehicle, a pedestrian, an animal), information as to whether the potential obstacle is moving, usage of the brakes and signals (e.g., blinkers) when the potential obstacle is a vehicle, a lane position of the potential obstacle, and presence of a traffic intersection proximate the potential obstacle, among other possible information. In some embodiments, the motion planning module 410 similarly obtains other data as part of the sensor data 412, such as passenger inputs (e.g., as to a desired destination) and/or remote data from sources outside the vehicle 10 (e.g., from GPS systems, traffic providers, and so on). In various embodiments, the motion planning module 410 gathers this information and generates driving plan data 415 as outputs for the motion planning module 410, which are provided to the plan implementation module 420 described below.

The plan implementation module 420 receives the driving plan data 415 from the motion planning module 410, performs analysis using the received driving plan data 415, and generates instructions 425 as appropriate for operation of the vehicle 10 in respect to the analysis. For example, in various embodiments, the plan implementation module 420 uses the driving plan data 415 to instruct the vehicle 10 to drive using a first driving plan for continuing on a path to a destination and to instruct the vehicle 10 to drive using a second driving plan for bringing the vehicle to a stop at less than a maximum braking rate. Also in various embodiments, the plan implementation module 420 generates instructions 425 for operation of the vehicle 10 (e.g., for implementation via an automatic driving system, such as the ADS 70 of FIG. 3, and/or components thereof, and/or vehicle actuators, such as the actuators 42a . . . 42n of FIG. 1) in different manners based on whether the systems of the vehicle 10 are in good health. For example, in certain embodiments, the instructions 425 may be for the vehicle 10 to execute the first driving plan, the second driving plan, or a hard stop.

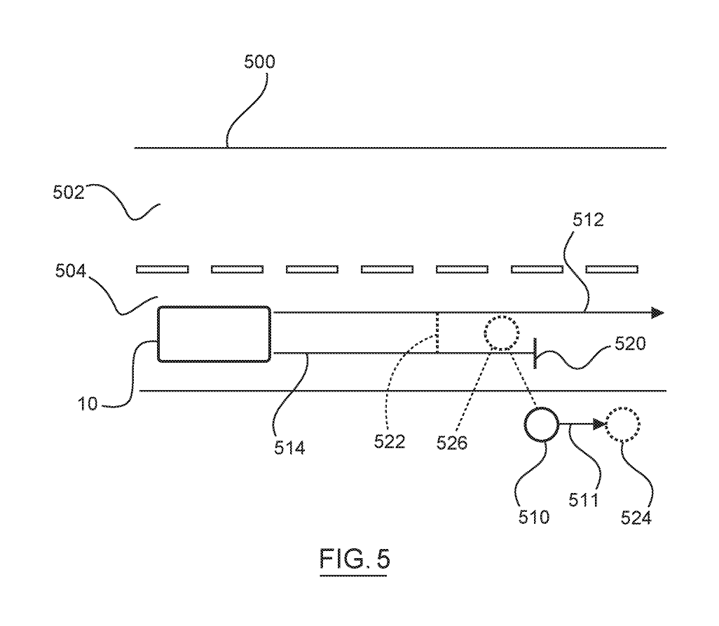

Turning now to FIG. 5, a schematic diagram is provided of the autonomous vehicle 10 in a particular environment in proximity to a potential obstacle 510, in accordance with various embodiments. As depicted in FIG. 5, in various embodiments the vehicle 10 is operating during a current vehicle ride along a roadway 500. In the depicted example, the roadway 500 includes two lanes 502, 504, with the vehicle 10 operating in current lane 504. Also as depicted in FIG. 5, the potential obstacle 510 is disposed adjacent to the lane 504 traveling in the same direction as the vehicle 10 along a path 511.

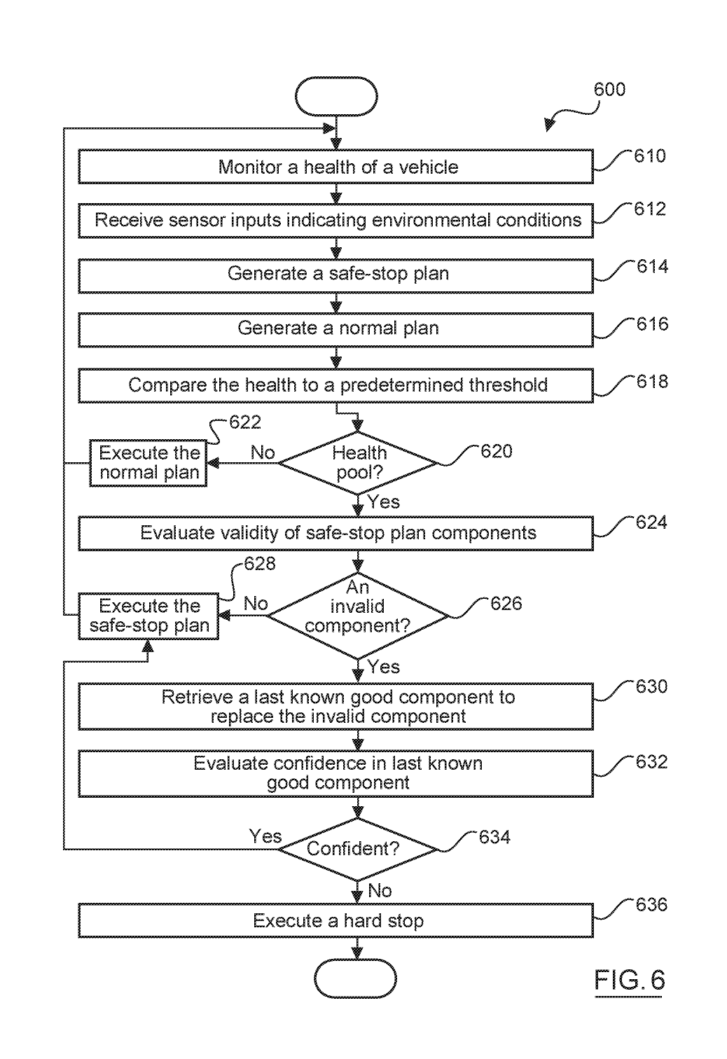

As will be set forth in greater detail below with respect to the control method 600 of FIG. 6, in various embodiments the vehicle 10 may execute the first driving plan 512 when a health of the vehicle 10 is good or may execute the second driving plan 514 when the health of the vehicle 10 is poor. The first driving plan 512 guides the vehicle 10 along roadway 500 to a final trip destination (not illustrated).

The second driving plan 514 brings the vehicle 10 to a stop at a predetermined rate configured to reduce passenger disturbance and rear-end collisions that may occur due to sudden vehicle stops. In the example provided, the second driving plan 514 initially plans to bring the vehicle 10 to a stop at a first stopping position 520, but revises the second driving plan 514 to bring the vehicle 10 to a stop at second stopping position 522 based on a confidence in the position of potential obstacle 510. For example, when updated information has not been received from motion planning module 410, plan implementation module 420 may determine that although potential obstacle is likely at predicted location 524, the likelihood that potential obstacle 510 is not at potential position 524—such as when potential obstacle 510 may be at potential position 526—is below a confidence threshold, as will be described below.

Referring now to FIG. 6, and with continued reference to FIGS. 1-5, a flowchart illustrates a control method 600 that can be performed by the stop contingency system 100 of FIG. 1 in accordance with the present disclosure. As can be appreciated in light of the disclosure, the order of operation within the method is not limited to the sequential execution as illustrated in FIG. 6, but may be performed in one or more varying orders as applicable and in accordance with the present disclosure. In various embodiments, the method 600 can be scheduled to run based on one or more predetermined events, and/or can run continuously during operation of the autonomous vehicle 10.

Task 610 monitors a health of a vehicle. For example, plan implementation module 420 may monitor the availability of various sensors 40a-40n, the timeliness of tracking and prediction calculations, the time since receiving a last driving plan, and various other indicators that the vehicle 10 may be performing sub-optimally.

Task 612 receives sensor inputs indicating environmental conditions and a location of a potential obstacle. For example, motion planning module 410 may receive input from sensors 40a-40 indicating the presence of potential obstacle 510 so that stop contingency system 100 may track the potential obstacle 510.

Task 614 generates a stop contingency or second driving plan configured to bring the vehicle to a stop at a predetermined rate. For example, stop contingency system 100 may generate the second driving plan 514 to bring the vehicle 10 to a stop at less than the full braking rate of the vehicle 10. The predetermined rate is at least partially based on predetermined driver reaction times to permit a driver following the vehicle to react to the vehicle decelerating while the vehicle 10 is executing the second driving plan. Accordingly, the predetermined rate is less than the maximum deceleration/braking rate of the vehicle 10.

In the example provided, generating the second driving plan includes generating a lateral component and generating a longitudinal component. For example, motion planning module 410 may generate the lateral component to control steering of the vehicle 10 and may generate the longitudinal component to control the throttle and brakes of the vehicle 10.

Task 616 generates a normal or first driving plan configured to guide the vehicle to a trip destination. As used herein, the term “trip destination” refers to the location where a user of the vehicle 10 is planning on departing the vehicle 10 or otherwise cease traveling in the vehicle 10. For example, motion planning module 410 may generate first driving plan 512 to guide the vehicle 10 toward the trip destination. In the example provided, the second driving plan and the first driving plan are generated concurrently. For example, the first driving plan and the second driving plan may both be generated and output by motion planning module 410 at substantially the same time so that a second driving plan is available if future conditions indicate the second driving plan is to be used. In some embodiments, one of the first driving plan or the second driving plan may be generated before the other of the first driving plan or the second driving plan.

Task 618 compares the vehicle health to a predetermined threshold. For example, plan implementation module 420 may determine whether the vehicle health is poor enough to indicate that the vehicle 10 should cease guiding the vehicle 10 with the first driving plan 512. As described above, unavailability of sensors, lack of response from motion planning module 410, and other conditions may be considered for determining the health of the vehicle 10 according to any suitable health monitoring technique. The condition of any specific system or sensor may be combined in any suitable manner with the condition of any other specific system or sensor to obtain the overall health of the vehicle 10.

Task 620 determines whether the vehicle health is poor. For example, stop contingency system 100 may determine that the vehicle health is below the predetermined threshold. As used herein, the terms “poor” and “good” refer to the health of the vehicle being below or above the predetermined threshold, respectively. When the health is not poor and is above the predetermined threshold, method 600 proceeds to task 622. When the vehicle health is poor and is below the predetermined threshold, method 600 proceeds to task 624. In the example provided, some predetermined indicators are weighted more heavily than others for determining whether the vehicle health is poor. For example, losing communication with dispatch may indicate that the normal plan should cause the vehicle 10 to pullover, while losing critical sensors such as Lidar may result in a safe stop. In some embodiments, the second driving plan may be implemented as a contingency plan in response to predetermined anomalous-behaviors.

Task 622 commands the vehicle to execute the first driving plan in response to the health of the vehicle staying above a predetermined health threshold. For example, plan implementation module 420 may instruct the vehicle 10 to drive the first driving plan 512 on roadway 500. Method 600 returns to task 610 after task 622 to receive further updates and adjust the first driving plan 512 as the vehicle 10 proceeds along the route.

Task 624 evaluates the validity of the stop contingency or second driving plan components. For example, plan implementation module 420 may determine whether the lateral component is a valid lateral component and whether the longitudinal component is a valid longitudinal component. As used herein, the term “valid” means that the component was successfully calculated by the motion planning module 420 and the term “invalid” means that the component was not successfully calculated by the motion planning module 420.

Task 626 determines whether the components are invalid. For example, plan implementation module 420 may determine the components are invalid when motion planning module 410 is not able to calculate the components. When the components are valid, method 600 proceeds to task 628. When the components are invalid, method 600 proceeds to task 630.

Task 628 commands the vehicle to execute the second driving plan in response to the health of the vehicle falling below the predetermined health threshold. For example, plan implementation module 420 may instruct the vehicle 10 to drive the second driving plan 514 on roadway 500 when the vehicle health is poor and the components of the second driving plan are valid.

Method 600 returns to task 610 after executing the second driving plan to modify the second driving plan based on new conditions indicated in task 612. For example, motion planning module 410 may adjust the second driving plan based on movement of potential obstacle 510 along path 511.

Task 630 retrieves a last known good component to replace the invalid component. For example, plan implementation module 420 may retrieve a previous valid lateral component as the lateral component in response to determining that the lateral component is not the valid lateral component and may retrieve a previous valid longitudinal component as the longitudinal component in response to determining that the longitudinal component is not the valid longitudinal component.

Task 632 evaluates a confidence in the last known good component. For example, stop contingency system 100 may evaluate the confidence in the last known good component based on how much time has passed since the last known good component was calculated.

Task 634 determines whether the confidence in the last known good component is above a confidence threshold. In the example provided, the confidence threshold is an amount of time since the last known good component was calculated. In the example provided, the plan validity is based on the uncertainty of the prediction horizon. For example, the confidence decreases faster in time when the object is moving fast and/or when the object was only partially tracked. For example, stop contingency system 100 may determine that the last known good component is below the predetermined confidence threshold when the last known good component was calculated more than five seconds before executing task 634. When the confidence in the last known component is above the confidence threshold, method 600 proceeds to task 628. When the confidence in the last known component is below the confidence threshold, method 600 proceeds to task 636.

Task 636 commands the vehicle to execute a hard stop in response to determining that a component confidence in one of the previous lateral component and the previous longitudinal component is below a predetermined confidence threshold. For example, plan implementation module 420 may instruct the vehicle 10 to apply a maximum braking force available in task 636.

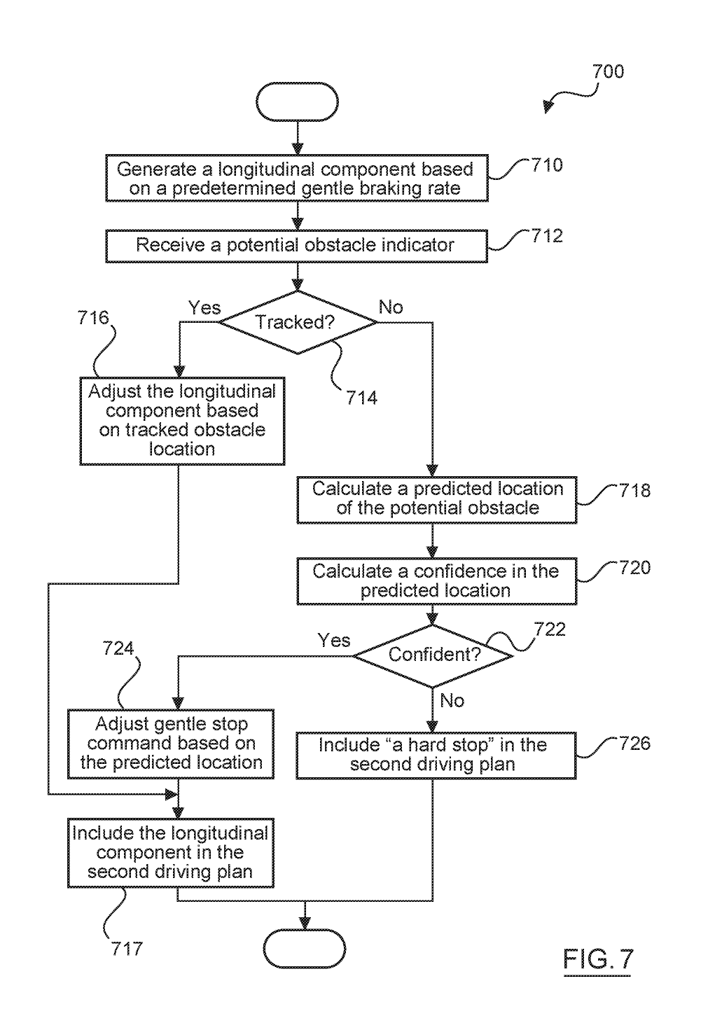

Referring now to FIG. 7, and with continued reference to FIGS. 1-6, a flowchart illustrates a control method 700 that can be performed by the stop contingency system 100 of FIG. 1 in accordance with the present disclosure. In some embodiments, the method 700 may be utilized to generate the second driving plan 514 as indicated in task 614 of method 600.

Task 710 generates a longitudinal component based on a predetermined gentle braking rate. For example, motion planning module 410 may generate the longitudinal component of the second driving plan 514 to stop at stopping position 520. The predetermined gentle braking rate is less than the full braking power of the vehicle to reduce passenger disturbance and risk of rear end collision from vehicles that may be following the vehicle 10.

Task 712 receives a potential obstacle indicator. For example, sensors 40a-40n may detect the presence of potential obstacle 510 and/or motion planning module 410 may infer the presence of a potential obstacle from previous sensor inputs, such as when sensors 40a-40n are unavailable and a previous driving plan indicated the presence of potential obstacle 510.

Task 714 determines whether the potential obstacle is currently being tracked. For example, plan implementation module 420 may determine that potential obstacle 510 is not being tracked when motion planning module 410 or sensors 40a-40 are unavailable. When the potential obstacle is being tracked, method 700 proceeds to task 716. When the potential obstacle is not being tracked, method 700 proceeds to task 718.

Task 716 adjusts the longitudinal component based on the tracked obstacle location. For example, motion planning module 410 may track potential obstacle 510 along path 511 to determine that the second driving plan 514 does not need updating and the vehicle 10 may still complete the stop at stopping position 520.

Task 717 includes the longitudinal component in the second driving plan. For example, plan implementation module 420 may update the second driving plan 514 based on the predetermined gentle braking rate.

Task 718 predicts a future location of the potential obstacle based on sensor inputs. For example, motion planning module 410 may predict that potential obstacle will be at predicted location 524 after one second based on path 511 determined by input from sensors 40a-40n. Task 720 calculates a confidence in the future position. For example, plan implementation module 420 may calculate the confidence based on the time of the last detection of potential obstacle 510 as at least part of the component confidence calculated in task 632 of method 600.

Task 722 determines whether the confidence in the future position is above a confidence threshold. In the example provided, the confidence threshold is an amount of time since the potential obstacle 510 was last tracked with consideration for the speed of travel, direction of travel, and uncertainties in the speed and direction of travel of the potential obstacle 510. For example, plan implementation module 420 may determine that the confidence in the future position is below the confidence threshold when it has been several seconds since last receiving a driving plan from motion planning module 410. When the confidence in the future position is above the confidence threshold, method 700 proceeds to task 724. When the confidence in the future position is below the confidence threshold, method 700 proceeds to task 726.

Task 724 adjusts the gentle stop command based on the predicted location. For example, motion planning module 410 may confirm the first stopping position 520 based on the predicted location 524 when sensors 40a-40n are unavailable.

Task 726 includes a hard stop in the second driving plan. For example, plan implementation module 420 may instruct the vehicle 10 to stop at a maximum braking rate when the predicted location 524 is several seconds old and motion planning module 410 has not sent an updated driving plan.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle with a processor, the method comprising:
monitoring a health of the vehicle;
generating a first driving plan;
generating a second driving plan configured to bring the vehicle to a stop at a predetermined rate;
commanding the vehicle to execute the first driving plan in response to the health of the vehicle staying above a predetermined health threshold; and
commanding the vehicle to execute the second driving plan in response to the health of the vehicle falling below the predetermined health threshold.

2. The method of claim 1, further comprising:
receiving sensor inputs indicating a potential obstacle; and
adjusting the second driving plan based on the potential obstacle.

3. The method of claim 1, wherein generating the first driving plan includes generating the first driving plan configured to guide the vehicle to a trip destination, and wherein generating the second driving plan includes generating a lateral component and generating a longitudinal component.

4. The method of claim 3, further comprising:
determining whether the lateral component is a valid lateral component;
determining whether the longitudinal component is a valid longitudinal component;
retrieving a previous valid lateral component as the lateral component in response to determining that the lateral component is not the valid lateral component; and
retrieving a previous valid longitudinal component as the longitudinal component in response to determining that the longitudinal component is not the valid longitudinal component.

5. The method of claim 4, further comprising commanding the vehicle to execute a hard stop in response to determining that a component confidence in one of the previous valid lateral component and the previous valid longitudinal component is below a predetermined confidence threshold.

6. The method of claim 5, further comprising:
tracking a potential obstacle based on sensor inputs;
predicting a future position of the potential obstacle based on the sensor inputs; and
calculating a confidence in the future position as at least part of the component confidence.

7. The method of claim 1, wherein the predetermined rate is at least partially based on predetermined driver reaction times to permit a driver following the vehicle to react to the vehicle decelerating while the vehicle is executing the second driving plan.

8. The method of claim 1, further comprising receiving updated sensor inputs and updating the second driving plan based on the updated sensor inputs after commanding the vehicle to execute the second driving plan.

9. A system for controlling a vehicle, the system comprising:
a motion planning module configured to at least facilitate, by a processor:
monitoring a health of the vehicle;
generating a first driving plan configured to guide the vehicle to a trip destination; and
generating a second driving plan configured to bring the vehicle to a stop at a predetermined rate; and
a plan implementation module configured to at least facilitate, by the processor:
commanding the vehicle to execute the first driving plan in response to the health of the vehicle staying above a predetermined health threshold; and
commanding the vehicle to execute the second driving plan in response to the health of the vehicle falling below the predetermined health threshold.

10. The system of claim 9, wherein the motion planning module is further configured to at least facilitate:
receiving sensor inputs indicating a potential obstacle; and
adjusting the second driving plan based on the potential obstacle.

11. The system of claim 9, wherein the motion planning module is further configured for generating the second driving plan by generating a lateral component and generating a longitudinal component.

12. The system of claim 11, wherein the plan implementation module is further configured to at least facilitate:
determining whether the lateral component is a valid lateral component;
determining whether the longitudinal component is a valid longitudinal component;
retrieving a previous valid lateral component as the lateral component in response to determining that the lateral component is not the valid lateral component; and
retrieving a previous valid longitudinal component as the longitudinal component in response to determining that the longitudinal component is not the valid longitudinal component.

13. The system of claim 12, wherein the plan implementation module is further configured to at least facilitate commanding the vehicle to execute a hard stop in response to determining that a component confidence in one of the previous valid lateral component and the previous valid longitudinal component is below a predetermined confidence threshold.

14. The system of claim 9, wherein the motion planning module is further configured to at least facilitate
tracking a potential obstacle based on sensor inputs;
predicting a future position of the potential obstacle based on the sensor inputs; and
calculating a confidence in the future position as at least part of the component confidence.

15. The system of claim 9, wherein the predetermined rate is at least partially based on predetermined driver reaction times to permit a driver following the vehicle to react to the vehicle decelerating while the vehicle is executing the second driving plan.

16. The system of claim 9, wherein the motion planning module is further configured to at least facilitate receiving updated sensor inputs and updating the second driving plan based on the updated sensor inputs after commanding the vehicle to execute the second driving plan.

17. An autonomous vehicle comprising:
an autonomous drive system configured to operate the autonomous vehicle based on instructions that are based at least in part on a health of the vehicle;
a plurality of sensors configured to obtain sensor data pertaining to one or more potential obstacles in proximity to the autonomous vehicle; and
a processor operatively coupled with the plurality of sensors and to the autonomous drive system, the processor configured to at least facilitate:
monitoring the health of the vehicle;
generating a first driving plan configured to guide the vehicle to a trip destination;
generating a second driving plan configured to bring the vehicle to a stop at a predetermined rate;
commanding the vehicle to execute the first driving plan in response to the health of the vehicle staying above a predetermined health threshold; and
commanding the vehicle to execute the second driving plan in response to the health of the vehicle falling below the predetermined health threshold.

18. The autonomous vehicle of claim 17, wherein the processor is further configured to at least facilitate:
receiving sensor inputs indicating the one or more potential obstacles; and
adjusting the second driving plan based on the potential obstacle.

19. The autonomous vehicle of claim 17, wherein the processor is further configured to at least facilitate:
determining whether a component of the second driving plan is a valid component;
retrieving a previous valid component as the component in response to determining that the component is not the valid component.

20. The autonomous vehicle of claim 19, wherein the processor is further configured to at least facilitate commanding the vehicle to execute a hard stop in response to determining that a component confidence in the valid component is below a predetermined confidence threshold.
